(19) United States
(12) Patent Application Publication
(10) Pub. No.: US 2016/0344535 A1
(43) Pub. Date: Nov. 24, 2016

(54) Method for Improving Efficiency of a WLAN Network

(71) Applicant: QUALCOMM TECHNOLOGIES International, Ltd., Cambridge (GB)

(72) Inventor: Naveen Kumar KAKANI, Coppell, TX (US)

(21) Appl. No.: 14/719,796

(22) Filed: May 22, 2015

(51) Int. Cl. H04L 5/14; H04W 72/04; H04L 5/00

(52) U.S. Cl. CPC H04L 5/1438; H04L 5/0033; H04W 72/048; H04W 84/12

(57) ABSTRACT

Methods for improving communication channel use in a WLAN network are disclosed. According to certain aspects of the invention, a first wireless station in the WLAN network transmits over a communication channel a first data unit to a second wireless station in the WLAN network. The first data unit contains information identifying a wireless station in the WLAN network. Based on the received identifying information, the identified wireless station can transmit data to the first wireless station using the same communication channel without processing delay on a unit by unit basis. According to certain other aspects, embodiments of the invention include methods that allow an identified wireless station to send consecutive data units to the first wireless station with minimal latency.

### FIELD OF THE INVENTION

The present invention relates generally to wireless networking, and more particularly to methods for efficiently using communication channels of a WLAN network with both duplex and half duplex wireless stations.

### BACKGROUND OF THE INVENTION

A Wireless Local Area Network (WLAN) generally consists of either independent basic service sets (BSSs) or infrastructure BSSs. The independent BSSs are also referred to as Ad Hoc BSSs. An Infrastructure BSS usually includes one or more access points (AP), a distribution system, etc. and generally employs the AP in all communications including communication between wireless stations (STA). In most current wireless communication systems, APs and the non-AP wireless stations operate in half-duplex mode.

In application Ser. No. 14/213,987 entitled “Method and Apparatus for in-band full duplex wireless communications” for a wireless system that includes basic channel access in the presence of full duplex communications, co-existence with legacy non-full duplex IEEE 802.11 systems, a mechanism is disclosed to schedule full duplex transmissions, support for full duplex communications with half duplex STAs and the transmission of acknowledgements from the full duplex receiving devices. As a background, the specification of application Ser. No. 14/213,987 is incorporated here as a by reference as if fully set forth herein.

FIG. 1 illustrates an example operation between a full duplex AP and two half-duplex STAs according to the existing IEEE 802.11 specification with the modifications disclosed in the above invention.

In FIG. 1, AP transmits a Physical Layer Protocol Data Unit (PPDU) (PPDU_1) to a wireless station STAy. As a Full Deplex device, AP includes in PPDU_1 the signaling that another half-duplex wireless station STAx can transmit data to AP in the uplink direction of the channel while PPDU_1 is still being transmitted to STAy. Upon receiving the PPDU_1, STAx processes the signaling field in the preamble and then sends its data to AP during the remaining time of PPDU_1 duration. Because it takes time dT for STAx to process the PPDU_1 header and decode which station is scheduled to send data to AP, the actual time STAx can utilize the channel in the uplink direction to send data to AP is truncated, i.e., the duration of PPDU_1 subtracted by dT. As a result, the channel in the uplink direction is not fully utilized.

Additionally, when the duration of a PPDU_1 is very short, dT is comparable to the duration of PPDU_1. For example, AP to STAy transmission time is calculated as follows:

T_{APtoSTA TX}=T_{Preamble}+T_{MAC Header+MPDU of length 1500 bytes} (1)

For transmission data rate at 6 Mbps, it becomes:

T_{APtoSTA TX}=T_{Preamble}+50 μs+2000 μs*Num_of_MPDUS (2)

Or, for transmission data rate at 54 Mbps,

T_{APtoSTA TX}=T_{Preamble}+5 μs+223 μs*Num_of_MPDUS (3)

If dT is equal to the time of Preamble and MAC Header, and Num_MPDUS equals 1, this leaves little time available for STAx to transmit data using the channel in the uplink direction. The only way STAx can send an MPDU of 1500 bytes is if STAx were to use data rate higher than the transmission rate AP uses for the transmission to STAy. Otherwise, it is not possible for STAx to use the channel in the uplink direction to finish the transmission of its data in the allowed time. Accordingly, the current IEEE 802.11 or the invention disclosed in the application Ser. No. 14/213,987 does not support this uplink transmission from STA to AP when a PPDU transmitted from AP to STA is short.

This problem could potentially be mitigated by the aggregation feature that the current IEEE 802.11 specification supports, which allows for an AP to aggregate data intended to be transmitted to different STAs as long as the data transmitted is of the same Access Category. As there is larger amount of data to be transmitted by the AP to one or more STAs, this gives the STA sufficient time to transmit all of its MPDU data. Therefore, aggregation can reduce the inefficiency in using the channel in the uplink direction when the PPDU transmitted from AP to one STA is short.

However, even with this approach, additional latency results for transmitting data with access categories that are AC_VO and AC_VI (for audio and video). Also, for AC_VO and AC_VI traffic, typical IEEE 802.11 systems allow for a period of time called Transmission Opportunity (TXOP) to be used to complete the transmission of data related to that access category, and the data can be destined to different STAs in the network. However, given that the actual size of the data related to these access categories transmitted to each STA is small, the conventional mechanism that requires dT time to process the header will not allow for the medium to be used by an STA to transmit its data to the AP. The same is true even for longer period of time TXOP. Hence the STAs using the medium have to operate in a half-duplex mode for the entire TXOP period.

Accordingly there remains a need in the art for a solution that addresses the problems above among others.

### SUMMARY OF THE INVENTION

The present invention relates generally to wireless networking, and more particularly to methods for improving communication channel use efficiency of a WLAN network that contains both full duplex and half duplex wireless stations. Embodiments of the invention include changes in the PHY layer protocol in IEEE 802.11. According to certain aspects, embodiments of the invention include methods that allow an AP to signal in a PPDU as to which STA can transmit data to the AP during the following PPDU time thus improve the efficiency of communication channels for uplink transmission. According to certain other aspects, embodiments of the invention include methods that allow further improvement of the use of the communication channels by sending data from STA to AP when there is no need for acknowledgement for data from STA to AP.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates an example operation between a full duplex AP and half-duplex STAs of a WLAN according to a prior art.

FIG. 2 illustrates PPDU transmission time with new PPDU signaling for when ACK/BA frames are required by both AP and STA for the data just transmitted according to an embodiment of the invention.

FIG. 3A illustrates the timing and behavior of a data transmission between AP and an STA according to a prior art.

FIG. 3B illustrates the timing and behavior of the protocol and signaling of an embodiment of the invention for a data transmission when STAx does not require an ACK/BA frame for the data transmitted to an AP.

FIG. 4A illustrates the timing and behavior of a data transmission according to a prior art.

FIG. 4B illustrates the timing and behavior of the protocol and signaling of an embodiment of the invention for a data transmission when an AP does not require an ACK/BA for its data transmitted from an AP to an STA.

FIG. 5 is a flowchart illustrating an embodiment method of the invention.

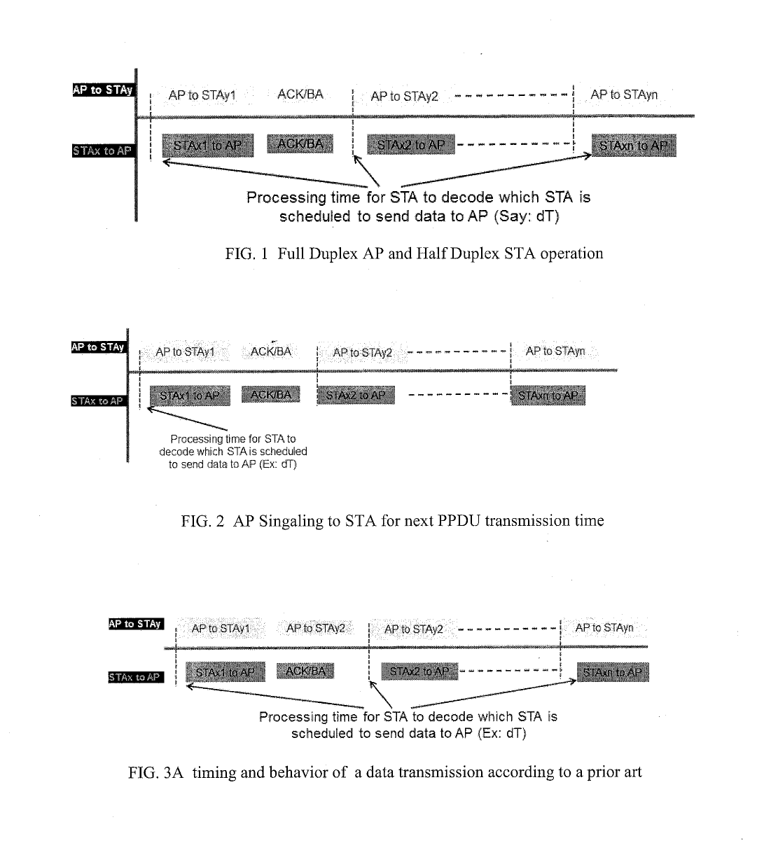

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to certain aspects, embodiments of the invention include methods that allow an AP to signal in an earlier PPDU about which STA can transmit data during the next PPDU time thus lower the inefficiency of using the uplink medium. According to certain other aspects, embodiments of the invention include methods that allow the efficiency of medium use to be further improved by sending data from STA to AP when there is no need for acknowledgement for data from STA to AP.

The present invention will be described below in conjunction with embodiments compatible with standards such as the IEEE 802.11. However, the invention is not limited to these embodiments, and the principles of the invention can be extended using other standards or proprietary or other wireless environments such as Bluetooth, Zigbee, etc that typically operate in half duplex mode.

In some embodiments of the invention, the STAs are typically any portable devices (e.g. iPhone or similar smartphone, iPad or similar tablet computer, smart watch, laptop or notebook computer, etc.) that have built-in WiFi and/or Bluetooth transceiver capabilities such as those provided in chipsets and associated firmware from manufacturers. Those skilled in the art will be able to implement the STA functionality of the invention by adapting such chipsets and/or firmware after being taught by the present examples.

In some embodiments of the invention, the AP device is a device that is wireless or wired and has full duplex capability. In some embodiments of the invention, a station that has full duplex capacity is used in place of an AP device.

To address the issues discussed above and other issues, some of the embodiments of the invention implement new behavior and functionality at an AP and the STAs of a WLAN network are discussed in more details below.

FIG. 2 illustrates new behavior with signaling for PPDU transmission time when ACK/BA frames are required by both AP and STA for the data just transmitted according to an embodiment of the invention.

In FIG. 2, the top row depicts the timing and duration corresponding to PPDUs and/or ACK/BA frames that an AP transmits in sequence to receiving wireless stations STAy over a communication channel in the downlink direction. For example, “AP to STAy1” is the first PPDU AP sends to STAy, ACK/BA is an acknowledgement frame AP sends to a transmitting wireless STAx for the first PPDU AP receives from a transmitting wireless station STAx, “AP to STAy2” is the second PPDU AP sends to the wireless station STAy, and so on.

The bottom row depicts the corresponding timing and duration of the PPDUs and ACK/BA frames that a transmitting wireless station STAx sends to the AP. For example, “STAx1 to AP” is the first PPDU STAx sends to AP, ACK/BA is the acknowledge frame STAy sends to AP for the first PPDU (“AP to STAy1”) it receives from AP, and “STA2 to AP” is the second PPDU STAx sends to AP, and so on.

In some embodiments of the invention, STAx and STAy are the same wireless station as long as it has a full-duplex capability. In some other embodiments of the invention, STAx and STAy are two different wireless stations each with only a hall-duplex capacity. For brevity and without the loss of generality, the following description with respect to FIG. 2 assumes STAx and STAy are different wireless stations.

During the transmission as depicted in FIG. 2, AP includes in the preamble of a PPDU (APtoSTAy1) to be transmitted the STA ID of the STA (STAx) that is allowed to use the channel in the uplink direction. As an example, the STA ID can be set in the AID field of the current PPDU that complies to the IEEE802.11.

As shown in FIG. 2, after a delay time of dT but during the same PPDU time frame, STAx transmits the first PPDU to AP (“STAx1 to AP”) using the channel in the uplink direction. The delay time dT is the processing time which STAx takes to decode the preamble of APtoSTAy1 to determine which STA is scheduled to send data to AP.

In some embodiments of the invention, the transmission of the first PPDU from AP to a wireless station STAy (“APtoSTAy1”) and the transmission of the first PPDU from STAx to AP (STAx1toAP) completes at the same time, as depicted in FIG. 2. It should be noted however, that in some other embodiments, the transmission of the two frames may end at different time, as depicted in FIG. 2 with respect to PPDU “STAx2toAP”.

In some embodiments of the invention, if AP expects an ACK/BA from STAy for the current PPDU1 that is being transmitted to STAy, AP also includes a bit in the header of the PPDU (“AP to STAy1”) to signal to STAx that STAx needs to hold off sending the next PPDU during the next data frame time.

In some embodiments of the invention, if AP uses a Block Acknowledgement (BA) instead of an ACK frame to acknowledge the received data, the wireless station STAx will need to use the same data rate for its BA frame as the data rate of the BA frame sent by AP to a wireless station STAy. It should be noted that if the AP does use/send a BA frame, the acknowledge frame sent by STAx can be either an ACK for a single MPDU or a BA for multiple MPDUs.

In some other embodiments of the invention, if AP does not require an ACK/BA from STAy for the current PPDU that is being transmitted to STAy, AP includes data in the header of the PPDU to signal to STAx that the next PPDU STAx sends to AP should not require an ACK/BA right immediately after that next PPDU transmission is completed. This is discussed further below with respect to FIGS. 4A and 4B.

Returning to FIG. 2, once the transmission of the respective PPDUs is completed, AP sends an ACK frame to STAx to acknowledge its receipt of the first PPDU from STAx, and receives from STAy the ACK frame for the PPDU STAy receives from AP.

According to some embodiments of the invention, in the TXOP case as discussed above, STAx needs to send multiple PPDUs to AP. However, having decoded the header of the PPDU(“AP to STAy1”), STAx knows that AP expects an BA frame from STAy, STAx waits after the ACK/BA frame is finished and then immediately sends the next PPDU to AP.

After transmission of the ACK/BA frames is completed, STAx starts transmission of the second PPDU (STAx2toAP) to AP at the same time when AP starts its transmission of the second PPDU to STAy (APtoSTAy2). Note that there is no processing time delay for the transmission of the second PPDU (STAx2toAP) as STAx2 already knows that it has the permission to use the channel in the uplink direction based on the decoding and processing of the preamble and additional signaling in the data transmitted from APtoSTAy1, as discussed above. The efficiency in using the channel in the uplink direction is therefore improved.

In the above discussion, AP sends multiple PPDUs consecutively to the same STAy, i.e., “AP to STAy1,” “AP to STAy2,”. . . and “AP to STAyn” represent the multiple PPDUs AP sends to STAy. It should be apparent to a person of ordinary skill in the art that AP may also send PPDUs to different STAs. For example, “AP to STAy1” may be the last of the data unit that AP transmits to a wireless station STAy1. After the ACK/BA, AP sends a PPDU to a different STA (STAy2), and to another different STA after that. As long as AP does not change its permission for STAx to use the uplink of the channel, the above discussion of the invention with respect to the improvement of channel use in the uplink direction still applies.

In some embodiments of the invention, the AP identifies in the PHY header the STA ID of an STA allowed to use the channel in the uplink direction during the current PPDU time, and then identifies the STA ID and duration in terms of the number of PPDUs or the actual PPDU duration allowed in either the PHY header or MAC Header or MAC frame of PPDU1 to STAy. This flexibility in the signaling is due to the fact that the timing for a receiving STA that is going to use the channel in the uplink direction during the next PPDU (that is not ACK/BA frame) is not timing critical.

In some embodiments of the invention, if the same STA (i.e., the STAx identified in the PHY header of the current PPDU duration) is allowed to use the channel in the uplink direction after its transmission of its PPDU, AP uses just a single bit to signal to the permission to STAx.

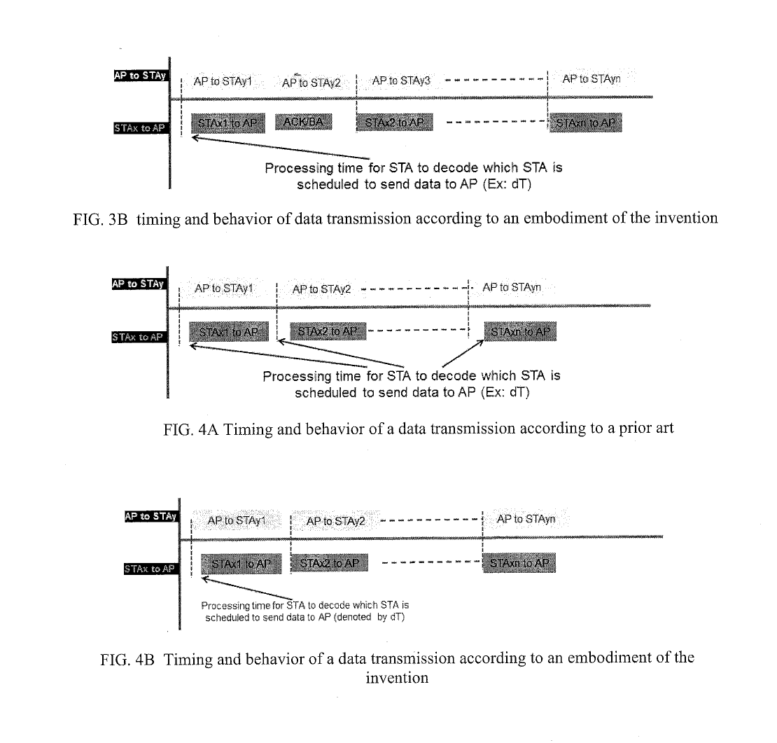

FIG. 3A illustrates the timing and behavior of a data transmission between AP and an STA when an STA does not require an ACK/BA frame for its PPDU data transmitted to an AP, according to the improvement over the current IEEE 802.11 as claimed in application Ser. No. 14/213987.

FIG. 3B illustrates the timing and behavior of the protocol and signaling of an embodiment of the invention for the same data transmission.

In FIG. 3A, according to the invention claimed in application Ser. No. 14/213,987, as discussed above, STAx starts to transmit data to AP after dT, the processing time that STAx takes to decode and learns that it is permitted to use the channel in the uplink direction for the remainder of the PPDU time while that PPDU is being sent from AP to STAy. Because STAx does not require an ACK/BA from AP for its data to AP, AP immediately starts to send a second PPDU to an STAy. At the same time, STAy starts to send a required ACK/BA frame to AP for the first PPDU data it just received from AP. After the ACK/BA frame, AP may or may not send STAx a second PPDU. But in any event, according to the prior art, the STA still needs to decode which STA is scheduled to send data to AP. The same decoding process is repeated for every time when the STA needs to use the channel for the uplink direction to send a PPDU to the AP. Consequently, significant amount of aggregated channel time in the uplink direction is wasted.

Turning to FIG. 3B, according to an embodiment of the invention, while receiving the ACK/BA frame from STAy for the first PPDU received from AP, AP signals to STAx2 (or STAx for the second PPDU) to use the channel in the uplink direction at the next PPDU time period. STAx 2 (or STAx) thus has plenty of time to decode and find out that it can use the channel in the uplink direction during the next PPDU time frame. Immediately after the ACK/BA and without any delay for header processing and decoding, STAx starts to send its next PPDU data to AP. Thus, only for the first PPDU, the time available for using the channel in an uplink direction for an STA to send data to AP is truncated by the processing time dT; for any subsequent PPDU data units the STA sends to AP, the STA has the channel in the uplink direction for the full PPDU duration. This is because AP has signaled in the previous PPDU duration which STA is scheduled to use the channel in the uplink direction to send data to AP in the subsequent PPDU time frames. As such, the use of the channel in the uplink direction has been significantly improved.

It should be noted that the wireless station STAx that is transmitting data to the AP needs to complete its transmission before or exactly at the end of PPDU transmission by AP to an STAy.

It should also be noted that because the time duration of a PPDU data frame maybe different from the time duration of an standard ACK/BA frame, as depicted in FIG. 3A. To account for this difference, in some of embodiments of the invention, the STAx implements a local counter to account for the time difference between the PPDU frame and the ACK/BA frame so that it will not prematurely starts to send the next PPDU. It should be apparent that the counter can be implemented in software, or hardware or the combination of the two. In yet some other embodiments, a wireless station STAx that is transmitting data to the AP, and that has completed its transmission of a PPDU frame before the end of a current PPDU transmission by AP will start a timer for reception of an ACK/BA frame only after the end of the current PPDU transmission by AP

In the above discussion, AP sends multiple PPDUs consecutively to the same STAy, i.e., “AP to STAy1,” “AP to STAy2,” . . . and “AP to STAyn” represent the multiple PPDUs AP sends to STAy. It should be apparent to a person of skill in the art that AP may also send PPDUs to different STAs. For example, “AP to STAy1” may be the last of the data unit that AP transmits to a wireless station STAy1. After the ACK/BA, AP sends a PPDU to a different STA (STAy2), and to another different STA after that. As long as AP does not change its permission for STAx to use the uplink of the channel, the above discussion of the invention with respect to the improvement of channel use in the uplink direction remains true.

FIG. 4A illustrates the timing and behavior of the protocol and signaling of the data transmission between AP and STAs when AP does not require an ACK/BA for the data transmitted to an STA according to the improvement over the current IEEE 802.11 as claimed in application Ser. No. 14/213,987. FIG. 4B illustrates the expected timing and behavior of the protocol and signaling of an embodiment of the invention for the same data transmission.

In FIG. 4A, the behavior of the data transmission according to IEEE 802.11 is similar to that as depicted in FIG. 3A. The only difference is that STAx starts transmitting a PPDU to AP after the previous PPDU without waiting for an ACK/BA frame from an STA to the AP first because AP does not require an ACK/BA for data transmitted to STAy. However, for every PPDU an STAx sends to AP, the actually channel time available for uplink transmission is still truncated by the processing time just as discussed above with respect to FIG. 3A. In other words, the same issue with inefficient use of the upper link of the channel persists.

Turning to FIG. 4B, similar to the behavior depicted in FIG. 3B, only the time for sending the first PPDU data unit from an STAx to AP using the channel in the uplink direction is truncated by the processing time an STAx needs to decode a PPDU header. After the first PPDU transmission using the channel in the uplink direction, STAs can send PPDU data to AP using the full duration of a PPDU time due to the aspect of the invention that AP always signals in the current PPDU time period which STAx is permitted to use the channel in the uplink direction for data transmission during the next PPDU time frame. The fact that AP does not require an ACK/BA for data transmitted to STAy makes the data transmission using the channel in the uplink direction streamlined and most efficient. It should be noted that, since the data transmitted by the AP does not require an ACK/BA response from the receiving STA, the data transmitted by STAs should also not require any ACK/BA response from the AP.

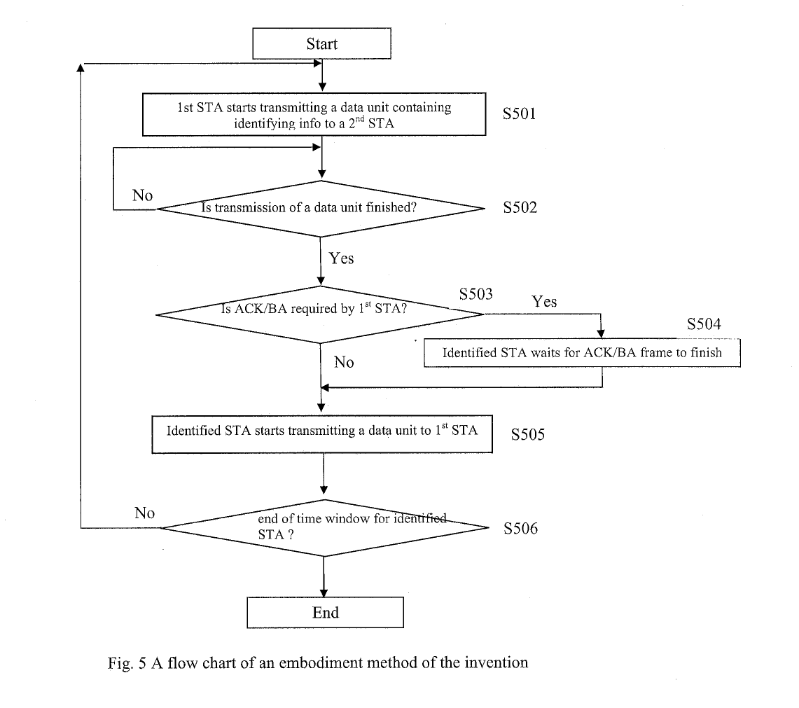

FIG. 5 is a flowchart illustrating an example signaling and behavior between a wireless station with full duplex capacity serving as an AP in a WLAN and two half-duplex wireless stations in the WLAN to implement this new behavior and functionality according to an embodiment of the invention.

At step 501, a first wireless station in the WLAN starts transmitting a first data unit over a communication channel to a second wireless station in the WLAN network. The first wireless station includes in the data unit header information identifying a wireless station in the WLAN network to signal that identified wireless station can transmit data to the first wireless station using the communication channel in the uplink direction.

At S502, the identified wireless station waits to see if the transmission of the first data unit has completed. According to some embodiments, the identified wireless station uses a counter to determine whether the transmission of the data unit from the first wireless station to the second wireless station is completed based on the information contained in the identifying information it decodes. In some embodiments, the second wireless station and the identified wireless station are the same full duplex device.

In some embodiments, the identifying information contained in the header of the first data unit further contains information to signal to the identified wireless station to wait for an acknowledgement data frame before transmitting a data unit to the first wireless station. If this is the case, the identified wireless station determines (S503) based on the identifying information it received whether the first wireless station expects an ACK/BA frame after finish sending the data unit. If yes, the identified wireless station waits for an acknowledgement data frame to finish (S504) before starts to transmit a data unit to the first wireless station (S505).

If the further information signals that no ACK/BA frame is expected after the current data frame, the first wireless station starts transmitting another data unit during the next transmission time period. The identified wireless station starts transmitting a data unit to the first wireless station (S505) at the same time as the first wireless station starts its transmission.

As discussed above, when the first station has acquired the channel for communication for the TXOP period and signals to the identified wireless station to use the entire TXOP time window, the identified wireless station checks to see if it has finished sending all the data units for the TXOP time window at S506. If not, the identified wireless station returns to step S502 to repeat the process for sending another data unit to the first wireless station. If yes, the process may return to step S501 and the first station may include in a new data unit identifying information signaling to the same or a different wireless station to use the communication channel in the uplink direction.

It should be apparent that many variations can be made to the above protocol and signaling to achieve the same or similar result, and the invention is not limited to the examples discussed in FIGS. 3-5.

Additionally, Table 1 compares the various current behaviors and expected behaviors according to different embodiments of the Invention.

TABLE 1
The Signaling and Expected Behaviors of Different
Embodiments of the Invention

| AP | STAx | | |
|---|---|---|---|
| to STAy | to AP | | |
| behavior | behavior | Current Behavior | Expected Behavior |
| AP to STAy | STAx to | STAy sends | STAy sends ACK/BA |
| data needs | AP doesn't | ACK/BA to AP, | to AP, AP may or may |
| ACK/BA | need | AP may or may | not send a PPDU to |
| | ACK/BA | not send a PPDU | STAx |
| | | to STAx | |
| AP to STAy | STAx to | ACK/BA are sent | ACK/BA are sent in |
| data needs | AP needs | in both directions | both directions, but |
| ACK/BA | ACK/BA | | during the following |
| | | | PPDU transmission |
| | | | time from AP to STAy |
| | | | the UL transmitter is |
| | | | already known |
| AP to STAy | STAx to | AP sends ACK/BA | This behavior is |
| data doesn't | AP needs | to STAx, there is | prevented. If this were |
| need | ACK/BA | no data | to be allowed, there |
| ACK/BA | | transmission from | will be no change in |
| | | STAx to AP | UL transmission, but |
| | | | the STA to use the |
| | | | next PPDU time can |
| | | | be signaled aready |
| AP to STAy | STAx to | AP can send next | AP and STAx can send |
| data doesn't | AP doesn't | PPDU to STAy, | PPDU immediately at |
| need | need | STAx decodes the | the end of the current |
| ACK/BA | ACK/BA | PPDU and sends | PPDU |
| | | data to AP | |

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for improving communication channel use efficiency of a WLAN network with full duplex and half duplex wireless stations, comprising:
transmitting over a communication channel, from a first wireless station in the WLAN network, a first data unit to a second wireless station in the WLAN network, wherein the first data unit contains information identifying a wireless station in the WLAN network and causing the identified wireless station to transmit data to the first wireless station over the communication channel;
transmitting a second data unit from the identified wireless station to the first wireless station based on the received identifying information, wherein the transmission of the second data unit starts after the transmission of the first data unit is completed.

2. A method according to claim 1, wherein the first wireless station is a full duplex device in the WLAN network.

3. A method according to claim 1, wherein the identifying information contains further information to signal when the identified wireless station can start transmitting the second data unit to the first wireless station.

4. A method according to claim 3, wherein the further information signals to the identified wireless station to start transmitting the second data unit to the first wireless station at the same time when the first wireless stations starts transmitting a data unit that immediately follows the first data unit.

5. A method according to claim 1, further comprising transmitting a third data unit from the identified wireless station to the first wireless station over the same communication channel after transmission of the second data unit.

6. A method according to claim 5, wherein the identifying information further contains information to signal to the identified wireless station to wait for an acknowledgement data frame before transmitting the third data unit.

7. A method according to claim 5, wherein the identifying information further contains information to signal to the identified wireless station to start transmitting the third data unit to the first wireless station after the second data unit without waiting for an acknowledgement data frame from the first wireless station.

8. A method according to claim 5, wherein the identifying information further contains information to signal to the identified wireless station that the data sent to the identified wireless station does not require an acknowledgement frame or a block acknowledgement frame from the identified wireless station.

9. A method according to claim 8, the identifying information further contains information to signal to the identified wireless station to send to the first wireless station data that does not require an acknowledgement frame or a block acknowledgement frame from the first wireless station.

10. A method according to claim 1, wherein the identifying information also contains information specifying the time window during which the identified wireless station can use the communication channel to transmit one or more data units to the first wireless station.

11. A method according to claim 10, wherein the time window is specified in terms of number of Physical Layer Protocol data units (PPDUs).

12. A method according to claim 10, wherein the identified wireless station is permitted to use the communication channel for data transmission to the first wireless station during the entire period of the Transmission Opportunity (TXOP) of the first wireless station.

13. A method according to claim 1, wherein at least some of the identifying information is included in the MAC frame header of the first data unit.

14. A method according to claim 1, wherein at least some of the identifying information is included in the PHY header of the first data unit.

15. A method according to claim 1, wherein the second wireless station is a full duplex device and the identified wireless station.

16. A method according to claim 15, wherein the identifying information further contains information to signal to the identified wireless station to send an acknowledgement data frame to the first wireless station.

17. A method according to claim 15, wherein the identifying information further contains information to signal to the identified wireless station the data sent to the identified wireless station does not require an acknowledgement frame or a block acknowledgement frame from the identified wireless station.

18. A method according to claim 17, wherein the identifying information further contains information to signal to the identified wireless station to send to the first wireless station data that does not require an acknowledgement frame or a block acknowledgement frame from the first wireless station.

19. A method according to claim 1, further comprising the first wireless station transmitting an acknowledgment data frame to the second wireless station after receiving data from the second wireless station.

20. A method according to claim 19, wherein the acknowledgement data frame is one of an ACK frame acknowledging receipt of a single MPDU or a block acknowledgement (BA) frame acknowledging receipt of multiple MPDUs.

21. A method according to claim 20, wherein the first wireless station sends a BA frame to the second wireless station and the identified wireless station uses the same data rate as that of the block acknowledge frame to send acknowledge data frame to the first wireless station.

22. A method according to claim 19, further comprising the second wireless station sending an acknowledgement frame to the first wireless station.

23. A method according to claim 22, wherein the acknowledgement frame from the second wireless station to the first wireless station can be either an ACK frame or a BA frame if a BA frame is used by the first wireless station to acknowledge data received from the second wireless station.

24. A method according to claim 1, wherein the identified wireless station finishes transmitting the second data unit to the first wireless station before or exactly at the end of the transmission of the first data unit.

25. A method according to claim 1, wherein the identified wireless station is a half-duplex device.
